(19) United States
(12) Patent Application Publication
(10) Pub. No.: US 2021/0319514 A1
(43) Pub. Date: Oct. 14, 2021

(54) SYSTEM AND COMPUTER-IMPLEMENTED METHOD FOR CREATING DIGITAL PATHWAYS BETWEEN FINANCIAL SERVICE PROVIDERS AND CONSUMERS

(71) Applicant: Aubrey Jones, Oklahoma City, OK (US)

(72) Inventor: Aubrey Jones, Oklahoma City, OK (US)

(21) Appl. No.: 17/225,355

(22) Filed: Apr. 8, 2021

Related U.S. Application Data
(60) Provisional application No. 63/007,318, filed on Apr. 8, 2020.

(51) Int. Cl. G06Q 40/06

(52) U.S. Cl. CPC G06Q 40/06

(57) ABSTRACT

A combinatorial computer-based information system (CBIS) and computer-implemented method in consumer financial services and marketing strategies for providers and consumers using data science(s) and reciprocate Socratic teaching and learning communication methodologies is disclosed. The system and method create a digital pathway to inclusion, accelerating branding and national distribution channels.

### RELATED APPLICATIONS

This application claims priority from, U.S. Provisional Patent Application Ser. No. 63/007,318, entitled “System and Computer-Implemented Method for Creating Digital Pathways Between Financial Service Providers and Consumers” filed Apr. 8, 2020, the disclosure of which is hereby incorporated by reference.

### FIELD OF THE INVENTION

This invention generally relates to a system and computer-implemented method for creating digital pathways between financial service providers and consumers, and more specifically to combined computer-based information systems and computer-implemented methods in consumer financial services and marketing strategies for providers and consumers using data science(s) and reciprocatively Socratic teaching and learning communication methodologies.

### BACKGROUND OF THE INVENTION

Exclusion from digital pathways creates iniquities in the financial lives of consumers, making it more costly and riskier for them to perform basic financial activities. It also makes it costlier for providers in the financial services industry to perform transactions with them. Current digital systems are proven to be problematic and inaccessible, from a financial, information, and geographical perspective, to both institutions and consumers within the financial services industry. A growing body of evidence indicates that connecting consumers to a comprehensive digital financial system will generate sizable benefits for consumers and businesses in the financial service industry.

It is therefore desirable to provide an improved system and computer-implemented method for creating digital pathways between financial service providers and consumers.

It is further desirable to provide combined computer-based information systems and computer-implemented methods in consumer financial services and marketing strategies for providers and consumers using data science(s) and reciprocatively Socratic teaching and learning communication methodologies.

It is still further desirable to provide a system and computer-implemented method that creates a digital pathway to inclusion, accelerating branding and national distribution channels.

Before proceeding to a detailed description of the invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### SUMMARY OF THE INVENTION

In general, the invention relates a system and computer-implemented method for creating digital pathways between financial service providers and consumers, and more specifically to combined computer-based information systems and computer-implemented methods in consumer financial services and marketing strategies for providers and consumers using data science(s) and reciprocatively Socratic teaching and learning communication methodologies. The invention also relates to a system and method for incorporating the following method and system into a platform as a service (PaaS) technology.

The foregoing has outlined in broad terms some of the more important features of the invention disclosed herein so that the detailed description that follows may be more clearly understood, and so that the contribution of the instant inventors to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIG. 1 is a graphical user interface user frontend in accordance with an illustrative embodiment of the invention disclosed herein.

FIG. 2 is another graphical user interface user frontend in accordance with an illustrative embodiment of the invention disclosed herein.

FIG. 3 is another graphical user interface user frontend in accordance with an illustrative embodiment of the invention disclosed herein.

FIG. 4 is another graphical user interface user frontend in accordance with an illustrative embodiment of the invention disclosed herein.

FIG. 5 is graphical user interface lender backend in accordance with an illustrative embodiment of the invention disclosed herein.

FIG. 6 is another graphical user interface lender backend in accordance with an illustrative embodiment of the invention disclosed herein.

FIG. 7 is another graphical user interface lender backend in accordance with an illustrative embodiment of the invention disclosed herein.

FIG. 8 is another graphical user interface lender backend in accordance with an illustrative embodiment of the invention disclosed herein.

FIG. 9 is graphical user interface in accordance with an illustrative embodiment of the invention disclosed herein.

FIG. 10 is graphical user interface in accordance with an illustrative embodiment of the invention disclosed herein.

FIG. 11 is a flow chart of a critical thinking process in accordance with an illustrative embodiment of the invention disclosed herein.

FIG. 12 is a flow chart of a scientific method in accordance with an illustrative embodiment of the invention disclosed herein.

FIG. 13 is a flow chart of a consumer research process in accordance with an illustrative embodiment of the invention disclosed herein.

### DETAILED DESCRIPTION OF THE INVENTION

While this invention is susceptible of embodiment in many different forms, there is shown in the drawings, and will herein be described hereinafter in detail, some specific embodiments of the instant invention. It should be understood, however, that the present disclosure is to be considered an exemplification of the principles of the invention and is not intended to limit the invention to the specific embodiments or algorithms so described.

This invention generally relates to a system and computer-implemented method for creating digital pathways between financial service providers and consumers, and more specifically to combined computer-based information systems and computer-implemented methods in consumer financial services and marketing strategies for providers and consumers using data science(s) and reciprocatively Socratic teaching and learning communication methodologies.

The inventive system and computer-implemented method provide for an integrated digital financial system and method where consumers will experience direct benefits through several digital pathway channels. A range of financial service providers can offer its best possible products allowing customers to choose which offering is best for them, while enabling financial service providers to concentrate on the financial product design. Moreover, the system and computer-implemented method disclosed herein creates an interactive marketing platform between consumers and financial service providers by applying educational sciences to improve the knowledge and communal connectivity of both parties.

Currently, there are no clear digital pathways to widespread financial inclusion, and current systems and methods provide incomplete and probabilistic information creating inequities by making financial activities costlier and riskier for them to perform. Current systems and methods fail consumers by making it costly for providers/lenders to transact with them.

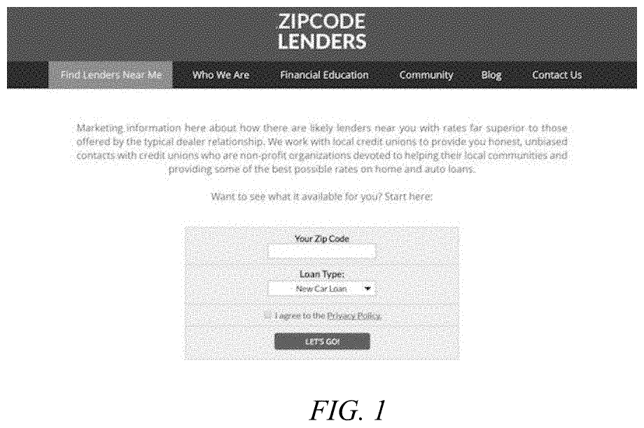

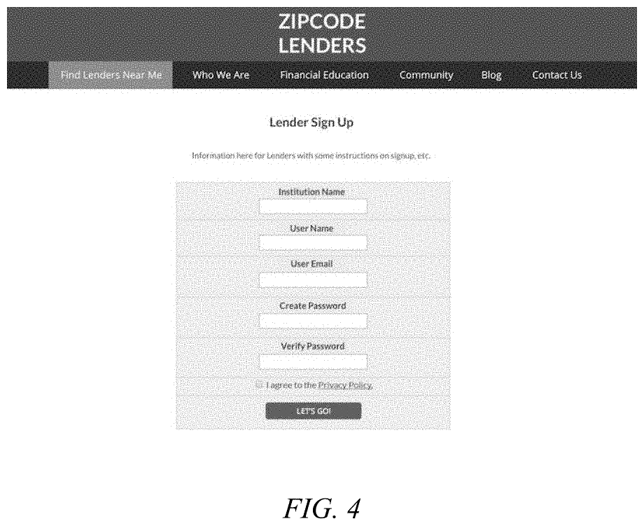

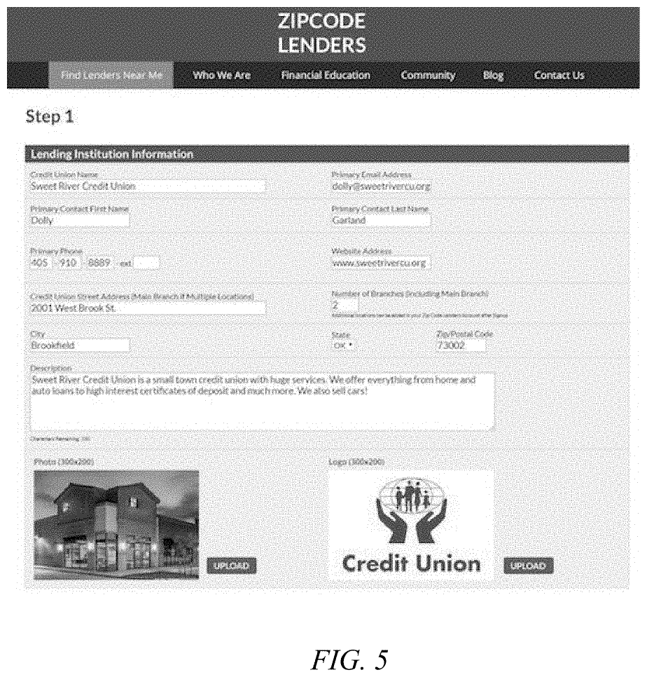

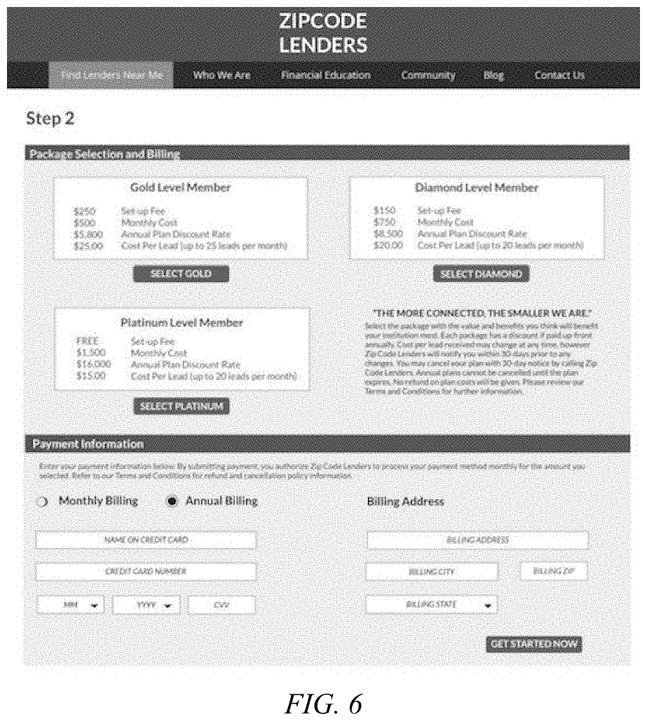

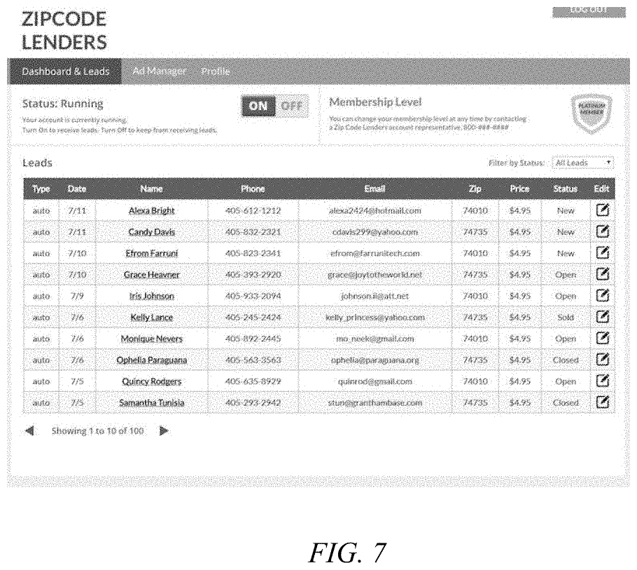

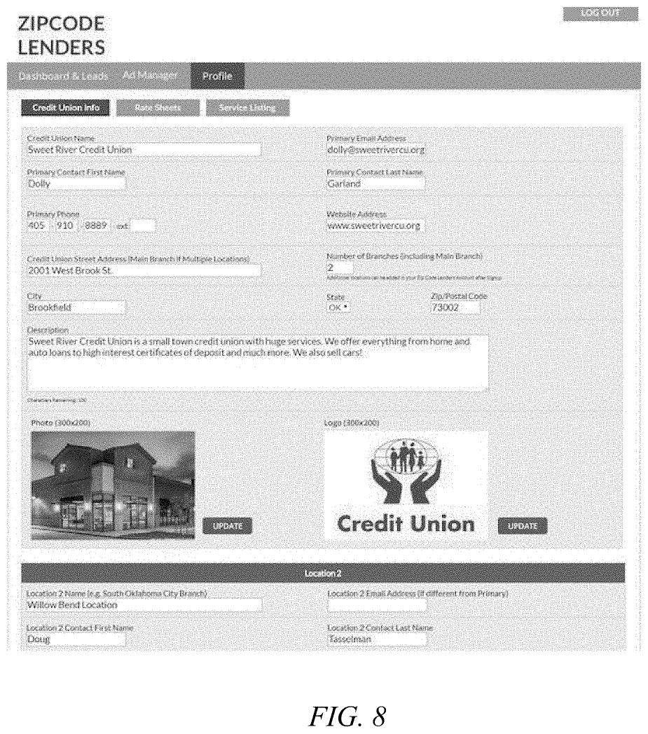

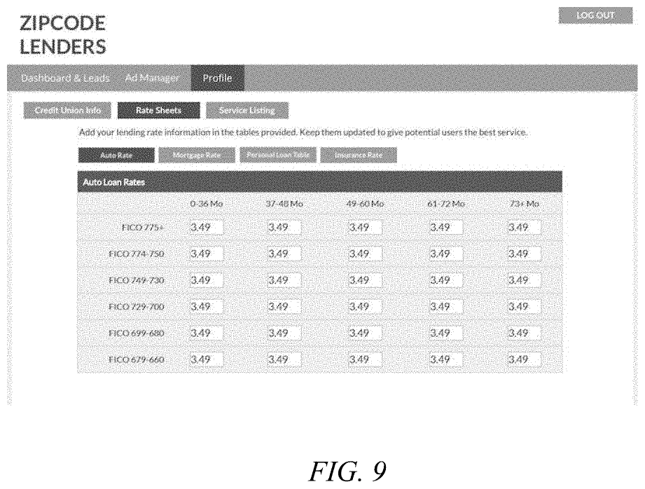

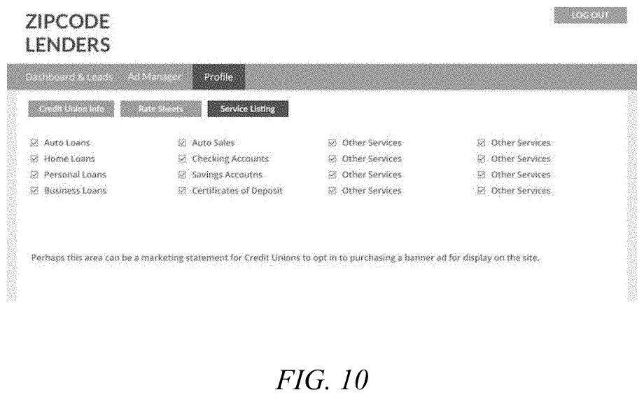

The inventive system and computer-implemented method include a user or consumer frontend (FIGS. 1-4), a financial service provider backend (FIGS. 5-9), and data analytics middleware (FIGS. 10-13). The user frontend will ask for the user's type of financial assistance needed, and the system will provide the user a preview of the number of providers in their area. Each provider has specific qualifications needed for a loan application, so each will be consulted using the financial service provider backend as they sign up to ensure the user form addresses any required questions. This will act as a guide and explain that filling out additional information will allow the site to focus on critical thinking and targeted results. If the user would like to see additional provider information, they must submit this information to the system. This ensures the system obtains the users information and data to be applied for educational and marketing strategy development. This also establishes a portal between the consumer and provider for information analysis and marketing strategies to the data analytics middleware.

The user frontend will request information in the form of cooperative dialogue and filtered questions between parties. Users will fill out a short form to determine their specific needs and see which providers in the system matches those needs. From there they will have the ability to self-select or have the system choose for them based on asking and answering questions. Educational questions can be added based on the providers instructive feedback and needs of participating provider(s). The system will let the user know and give them the ability to opt-in by going to the 2nd form step.

The data analytics middleware includes a reciprocative teaching and learning case analysis between consumer(s) and provider(s). A dialectic method of teaching and learning continuous feedback is created through cooperative and logical augmentations in the form of questions and answers stimulating critical thinking and collaboration for new ideas in the consumer financial services sectors, allowing for real business situations. Compiling lists of providers who match their criteria, the user(s) will also be able to review financial service offers by the provider(s) in their communities and/or regional boundaries and have the option to view more detail or select the provider/lender. If the provider is selected, both user and provider will be provided with the appropriate contact information, so follow-up can be made.

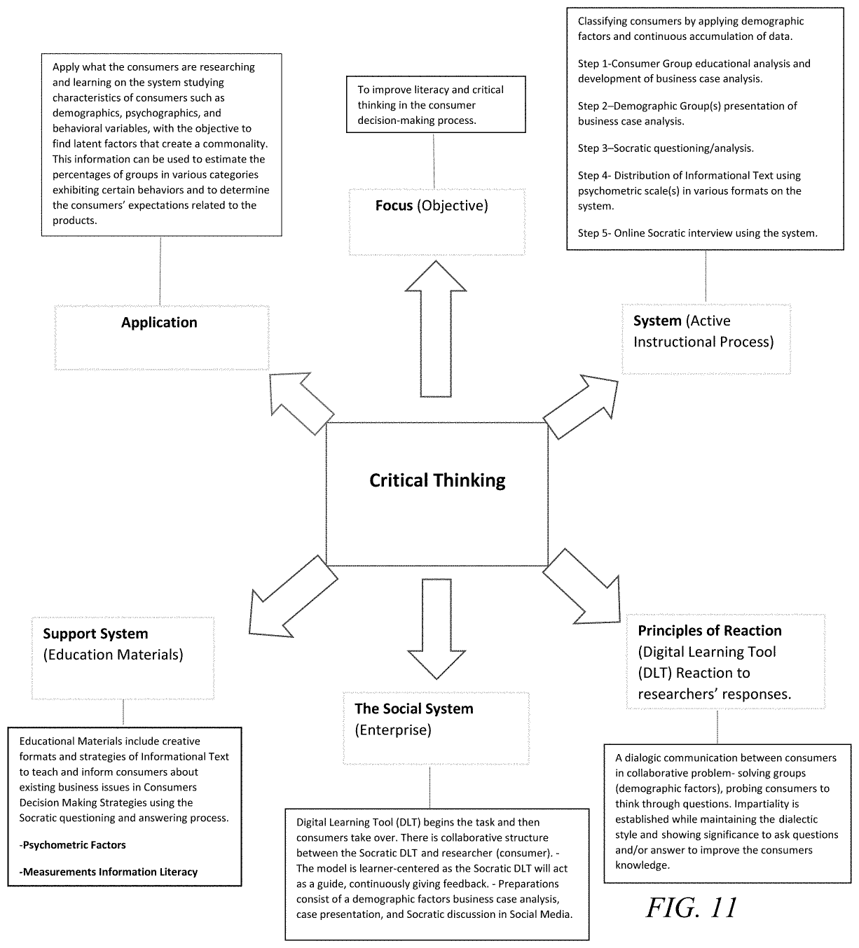

More specifically, as shown in FIG. 11, the method and system includes various critical thinking tools. The Focus of the system and method are to improve literacy and critical thinking in the consumer decision-making process to foster the development of intellectual traits or dispositions/virtues. Numeracy has been shown to predict more elaborate and heruistic searches (e.g., transforming probabilities, comparing relative magnitudes, and considering the time required to earn equivalent sums of money.

Additionally, the system utilizes an Active Instructional Process to classify consumers by applying demographic facts and continuous accumulation of data. The goal is to develop a systematic way of questioning and increase active and disciplined questioners within each subject of analysis. The Critical Thinking process also reviews Principles of Reaction which utilizes a digital learning tool (DLT) which reacts to researcher's responses. Further, the system utilizes a Social System as it collaborates between the Socratic DLT and researcher (consumer) where the DLT acts as a guide continuously giving feedback and reviews demographic factors, business case analysis, case presentation, and Socratic discussion on social media.

The Critical Thinking process also uses a Support System which includes educational materials with creative formats and strategies of informational text to teach and inform consumers about existing business issues in their strategies utilizing Socratic questioning and answering process. Finally, the Critical Thinking process of the system applies what consumers research and learn within the system by studying the characteristics of consumers including demographics, psychographics and behavioral variables, with the objective to find latent factors that create a commonality, which data can be used to estimate the percentages of groups in various categories.

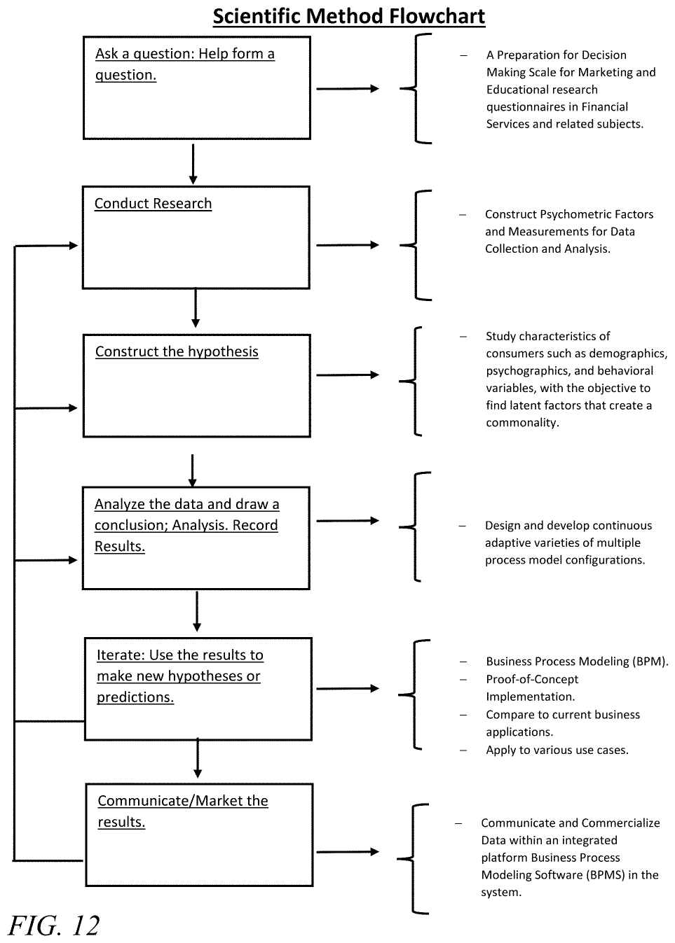

Turning now to FIG. 12, shown therein is a Scientific Method flowchart used by the system, wherein the process involves first asking a question, which may include the process of forming a question based on marketing and educational research questionnaires gathered in financial services and related subjects. Additionally this step may include conducting a systematic review of available literature. The purpose of a literature review is three-fold: (1) to survey the current state of knowledge in the area of inquiry, (2) to identify key authors, articles, theories, and findings in that area, and (3) to identify gaps in knowledge in that research area. The process utilizes Research Design, which is concerned with creating a blueprint of the activities to take in order to satisfactorily answer the research questions identified in the exploration phase.

Next, the process conducts research by constructing psychometric factors and measurement for data collection and analysis. This step may include the provision of guidance for public sector organizations. This step is important as consumers need to have stable representations of objects and events in memory that can be used for interpreting and evaluating objects and events in their environment. Strategies taught to consumers to break down frequency estimates into subcategories can reduce errors and processing effort as typically, research shows that information processing with respect to the self-increases elaborative thought and persuasion, such as when generating self-stories or when processing strong message arguments relative to the self.

Next the process constructs a hypothesis, which may include a study of characteristics of consumers, including demographics, psychographics, and behavioral variables with an objective of finding latent factors to create a commonality. This step includes concept design, artifact design and development sub-processes including utilization of a Business Platform Theory, using a model, which, rather than offering a specific product, enables the interactions between two or more players. The subject of discussion within the model is shared platforms which may be open to an unspecified number of complementary players. Various thesis in the field notes the following five points as the key variables including (1) designing a platform using communication patterns; (2) designing roles; (3) designing Incentives; (4) designing a mechanism to develop psychological conditions that are necessary for enabling collaboration among people; and (5) management of the internal changes of participants. Visual elements and numerical information have been found to convey meaning and influence these types of processes, such as information search, elaborative processing, attitudes, and consumption.

Next the process moves to the step of analyzing the data and drawing a conclusion and recording the results. This may include the design and development of multiple process model configurations. In practice, factor analysis is a data reduction technique that is used to statistically aggregate a large number of observed measures (items) into a smaller set of unobserved (latent) variables called factors based on their underlying bivariate correlation patterns. This step may also include a mixed-mode design to combine qualitative and quantitative data. This step creates new scientific insights, most importantly by gathering large-scale or hidden data, which researchers alone could not access by themselves. The cooperation involved on this step should produce an educational outcome, such as increasing knowledge and scientific interest among participants. Online tutorial materials may help to guarantee the quality of data collection processes and mobile applications tailored to social science research (“SSR”) methods may be useful to collect and share data in a secure way. Design science research often focuses on examining the utility of an artifact, however it has been suggested that the evaluation of the artifact is evaluated for its fitness to adapt and survive within an environment or by considering the social impacts of the artifact. Thus, science communication's success might be evaluated by whether the step produced choices closer to the ones that fully informed decision makers would make.

Next the process uses iteration to use the results to make new hypotheses and predictions of the data. This may include business process modeling (BPM), proof of concept implementation, comparison to current business methods and applications, and application to various use cases. The known design science research methodology process model attempts to synthesize selected prior literature on the topic by breaking the Awareness of Problem phase into two phases: (1) Identify Problem & Motivate, and (2) Define Objectives of a Solution. This step also merges the suggestion and development phases into a single phase—Design & Development. It then breaks the evaluation phase into two phases: (1) Demonstration, and (2) Evaluation.

The process then moves to rename the conclusion phase as communication. A distinguishing feature of this model is identification of the fact that the design science research process can be initiated from a variety of contexts—Problem-Centered Initiation, Objective Centered Solution, Design & Development Centered Initiation, Client/Context Initiation—and start in a corresponding phase of the nominal process sequence shown. The process then moves to a proof-of-concept implementation, which utilizes design science research to contribute to better theories (or theory building) which may utilize the methodological construction of an artifact is an object of theorizing for many communities (e.g., how to build more maintainable software), the development phase of a design science research effort may be an experimental proof of a method, an experimental exploration of a method, or both. Next, the process compares the research to current business applications. The research may be motivated by common problem awareness: that a better interface needs to be developed that will allow users to more quickly and effectively obtain answers to questions about the performance of their business operations.

Next, the process applies the results to various use cases. This collaboration allows users or consumer to provide valuable feedback on research designs and to help disseminate research findings in their communities and beyond. The creation of a fully developed theory, however, cannot be expected from a single design science research project. It usually gets created as a community effort through multiple iterations of research, development, and practice, and many times includes active participation of the industry, which is inherent in the proposed method and system.

Next, the process moves to communication and marketing of the results achieved and obtained by communication and commercialization of the data within an integrated platform business process modeling software (BPMS) within the system. This step includes collecting innovative, large-scale data, which may solve important scientific and social questions, SSR. This may include a method where the participants collect or analyze their own data. The process may implement SSR citizen science projects in a curriculum-based context. A sufficient pool of potential participants and the successful mobilization of this group is a key prerequisite for the successful implementation of a citizen science project. The cooperation with users and consumers will allow access to largescale and “hidden” data which are collected and provide an innovative potential for the knowledge production in SSR. The process may also create large databases by collecting and categorizing otherwise inaccessible social media content or may implement large-scale interviews with multiple target groups, which researchers could not reach on their own.

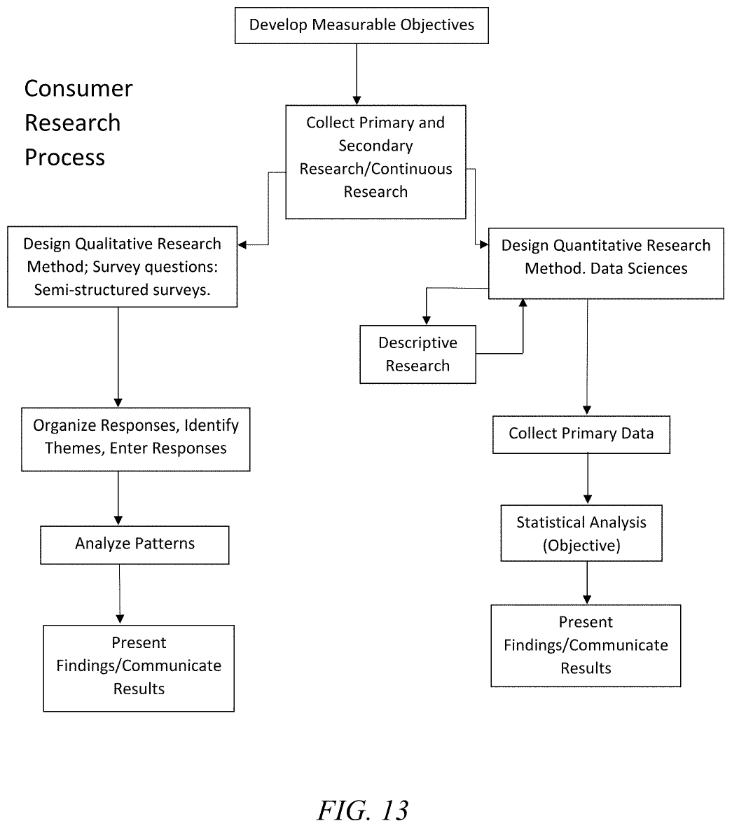

Turning to FIG. 13, shown therein is the Consumer Research Process of the system and method. First, the process includes the development of measurable objectives. The process then moves to the collection of primary and secondary research which includes ongoing and continuous research. The process then branches and in one part conducts a design of quantitative research method utilizing data sciences, and utilizes descriptive research on an ongoing basis. Next, the process collects primary data and performs a statistical analysis of the data using objective data. The process then presents the findings of the process and research through communication of those results. In another aspect, the process designs qualitative research method by utilizing survey questions and semi-structured surveys. It then organizes the responses from the surveys, identifies themes and enters those responses into the system database. The process then analyzes patterns in the responses and data gathered and finally presents the findings and research results.

The system and method can then communicate the findings and results to the user. The results page will develop a process of knowledge and curricula between the user(s) and provider(s) matching criteria to help make informed decisions. A provider list will be based on the user's community and geographic boundary location and responses to additional questions. Matching providers will receive the user's information.

A design for Six Sigma Methodology and the means disclosed herein consisting of the below-listed steps:
Define-(CBIS)—A Reciprocal Teaching and Learning Communications tool that supports decision-making, co-ordination and control as well as visualization and analysis in Consumer Financial Services. Identifying relational information wants and needs most important to both consumers and lenders by established metrics in Information Sciences and Technologies (concepts and methods), Data Analysis, Client Feedback, Statistics, and other information sources for continuous development.
Measure-Research and Development Data by licensed professionals in each category: Financial Services and Education; Marketing Strategies and Statistics; Digital Scientific Analysis Technology; Product Evaluation. Incorporated the DS (Design Science) Process to create and evaluate new properties in financial, technical, cognitive, social, and informational resources.
Analyze—Utilizing data provided by each professional organization the final processes was designed internally for assessment and measured improvements as needed for the customers and lenders aligned goals.
Design—The Design Science Research Methodology (DSRM) presented incorporates principles, practices, and procedures required to carry out such research and meets objectives: it is consistent with prior literature, it provides an economical process model for doing Design Research (DS), and it provides a mental model for presenting and evaluating DS research in Information Systems (IS). The process includes problem identification and motivation, objectives for a solution, design and development, demonstration, evaluation, and communication producing an innovative product.
Verify—With customer (consumers and lenders) reviews and feedback coming in, developments are made through a continuous improvement process linked back to the products goals and priorities leading to new applications in subsequent areas.

In the creation of the process, each element of the Design for Six Sigma (DFSS) DMADV Methodology is necessary.

Additional Lean Management/Techniques Design for Six Sigma and traditional Six Sigma are two concepts which share similar methodologies and tools which can be implemented to re-engineer the business process including, but not limited to:
DMAIC-Define, Measure, Analyze, Improve, Control.
IDOV-Identify, Design, Optimize, Verify.
IDDOV-Identify, Define, Design, Optimize, Verify.
DDICA-Design, Develop, Initialize, Control, Allocate.
DMADOV-Define, Measure, Analyze, Design, Optimize, Verify.

Additionally, the process consists of Technologies in Educational and Teaching; Marketing Strategies; Computer, Information, and Social Sciences; Data Sciences; Financial Services; Communal Services. This process can be commercialized in the Tertiary and Quaternary Industry's/Sectors including, but not limited to:
Financials: The financial sector consists of banks, investment funds, insurance companies and real estate firms, among others.
Utilities: The utilities sector consists of electric, gas and water companies as well as integrated providers.
Consumer Discretionary: The consumer discretionary sector consists of retailers, media companies, consumer service providers, apparel companies and consumer durables.
Industrials: The industrial sector consists of aerospace, defense, machinery, construction, fabrication and manufacturing companies.
Technology: The technology sector consists of electronics manufacturers, software developers and information technology firms.
Telecom: The telecom sector consists of wireless providers, cable companies, internet service providers and satellite companies, among others.

The system and computer-implemented method may include a database programed to perform database driven analytics using data sciences from various categories and professions (psychometrics, personality theories, marketing, product management, operations research, and finance) to study characteristics of consumers such as demographics, psychographics and behavioral variables and find latent factors that create a commonality. This information may then be processed to estimate the statistical data of groups in various categories exhibiting certain behaviors to determine the customers' expectations related to the products being offered, including:
database infrastructure and processing;
scripting languages: Python, etc.;
statistical computation: R, etc.;
machine learning;
experimental design;
Bayesian inferencing;
data visualization;
data storytelling;
data psychology.

The database processes information received from users of the web site to continually learn and analyze commonalities to require less human intervention based on how the users handle exceptions and responses to the information presented. Data that forms the basis of the day-to-day operations and management of the business having different characteristics, requiring integration and reconciliation before use in tracking performance, identifying problems, and setting directions to provide to the users. The process utilizes the collected and observed data and supplements it with prior and predicted data to drive the results, compiling the results by a collection of data from diverse sources on the user interface and website, including psychometric tests (i.e. probing questions). The data is then processed to be used on the user interface of the website.

The information listed below presents an accumulation and analysis of psychometric factors and measurements tools, such as creative formats and strategies of informational text and inputs throughout the website or user interface, which are stored in one or more databases, and processed by the system to create a consumer behavioral model (decision-making strategies) based on continuous and up-to-date real time data. The psychometric factors and measurements are specified for use in the web-based information system and database to be communicated between consumers and the business, such as financial organizations:

The system utilizes a process of applying various methods of input and processes on the web site to gather and interpret the data received from a user, these methods may include the following:
Literary Nonfiction-literary nonfiction includes shorter texts, such as personal essays, speeches, opinion pieces, essays about art or literature, biographies, memoirs, journalism, and historical, scientific, technical, or economic accounts (including digital sources) written for a broad audience, communicating factual information. Autobiographies, biographies, other narrative nonfiction, informational picture books, and informational poetry often fit into this category.
Expository Text-fact based with the purpose of exposing the truth through a reliable source (trade books, articles, reports, textbooks, interviews, and essays). Contain tables of contents, indexes, or other navigational devices so that readers may read only the portions that interest them. Expository texts utilize various text structures, such as description, cause and effect, comparison and contrast, problem and solution, question and answer, and temporal sequence. True and deliberate Expository Text will focus on educating its reader.
Argument or Persuasion Texts-provide evidence with the intent of influencing the beliefs or actions of the target audience. These texts typically include claims, evidence, and warrants to explain how the evidence is linked to the claims. Writers of persuasion or argument also make appeals—appeals to the author's credibility, to the audience's needs, or to reason and evidence.
Procedural Texts-provide step-by-step information or directions so that people can successfully perform activities in safe, efficient and appropriate ways. They often include a materials-needed section and graphics that illustrate the process. Directions, Instructions, Rules for Games, Recipes, Manuals, Agendas and Science Experiments are common examples of procedural texts.
Natural Observation—Natural Observation by using Socratic Games as a teaching method. Engage in a thinking process that will expand their understanding and therefore, their ability to play the game. Applying “What is” questions and answering each question in the form of a definition. This process of questioning and answering would continue until the fundamental questions on the subject area had been discovered and answered, where the consumer(s) gain a good understanding of the subject, stimulating Critical Thinking. To challenge accuracy and completeness of thinking in a way that acts to move consumers towards their ultimate goal
Case Studies—Obtaining detailed information about an individual to develop general principles about behavior.
Surveys/Probing Questions—The technique of gathering data by asking questions to people who are thought to have desired information.
Correlation Design—Understand what kind of relationships naturally occurring variables have with one another.
Experimental Methods—A study in which the investigator manipulates (at least) one variable while measuring (at least) one other variable. This method relies on controlled methods, random assignment and the manipulation of variables to test a hypothesis.
Personality analysis of the following five factors and one additional factor:
   Openness to Experience (Inventive/Curious vs. Consistent/Cautious). Willing to try new things vs. Pragmatic and data driven. Transformational.
   Conscientiousness (Efficient/Organized vs. Easy-Going/Careless). The average level of conscientiousness rises among young adults and then declines among older adults. Transformational.
   Extraversion (Outgoing/Energetic vs. Solitary/Reserved). Generally, people are a combination of extraversion and introversion. Transformational.
   Agreeableness (Friendly/Compassionate vs. Challenging/Detached). Agreeableness is a social trait. Possible-Transformational.
   Neuroticism (Sensitive/Nervous vs. Secure/Confident). Less Transformational.
   Honesty-Humility LSincere/Faithful vs. Deceitful/Greedy).
Normative Measurement—presents one statement at a time to a user to allow a respondent to use a five-point Likert-type scale to indicate the level of agreement they feel with the statement: from strongly disagree, disagree, neutral, agree and strongly agree.
Time-Use Survey—presents a statistical survey which aims to report data on how on average, people spend their time.
Satisfaction with Life-create/develop a revised Scale based on financial objectives and creatively integrate into website. Below are the statements used to determine an individual's satisfaction on the Satisfaction with Life Scale (SWLS). Use this as a model.
   In most ways my life is close to my ideal.
   The conditions of my life are excellent.
   I am satisfied with my life.
   So far, I have gotten the important things I want in life.
   If I could live my life over, I would change almost nothing.
Self-efficacy—The construct of perceived self-efficacy reflects an optimistic self-belief. This is the belief that one can perform a novel or difficult task, or cope with adversity—in various domains of human functioning. Perceived self-efficacy facilitates goal setting, effort investment, persistence in face of barriers and recovery from setbacks. It can be regarded as a positive resistance resource factor. (When I am confronted with a problem, I can usually find several solutions).
   “What kind of feedback did you get?”
   “How did that make you feel?”
   “What was the financial impact?”
   “Looking back, what would you do differently now, if anything?”
   What are you thinking about when you hear that question? Think Aloud
   What does that word or phrase mean to you? Probing
   What are most important factors in trusting a lender? Probing
Achievement Motivation-Typically self-motivated and process-oriented. The need for success or the attainment of excellence. Achievement-related attitudes include task-involvement—a task-involvement activity more often results in challenging attributions and increasing effort (typically in activities providing an opportunity to learn and develop competence) and will seek information relevant to attaining their goal of improving mastery in task-involving conditions. Some people strive to achieve their goals for personal satisfaction and self-improvement (Intrinsic Motivation), while others compete with their surroundings in achievement settings to simply be classified as the best (Extrinsic Motivation). (Structure the data analysis to address these “conditions/differences”).
Grit (Perseverance/Persistence)—Grit is functionally a measure of conscientiousness. Conscientiousness is seen as having six facets:
   Competence
   Order
   Dutifulness
   Achievement Striving
   Self-Discipline
   Deliberation
Cognitive Reflection-Decision Making and/or Behavioral Decision Theory (Normative)—The Cognitive Reflective Test (CRT), using Heuristics (Intuition/best guess/common sense) strategies to form judgments and make decisions and Normative Decision Theory, which analyzes the outcomes of decisions.
Crystallized Intelligence-Quick thinking and the ability to reason. Crystallized Intelligence refers to the accumulation of knowledge, facts, and skills that are acquired throughout life. Crystallized Intelligence continues to increase throughout adulthood and can be improved through learning.
Fluid Intelligence—Fluid intelligence refers to the ability to reason, think flexibly and solve problems. Fluid intelligence begins to decrease after adolescence (late adulthood). It is possible to improve fluid intelligence with brain training. Fluid and Crystallized Intelligence are intertwined. Crystallized intelligence is formed through the investment of Fluid Intelligence when information is learned. By using Fluid Intelligence to reason and think about problems, the information can then be transferred to long-term memory so that it can become part of Crystallized Intelligence. Improving Intelligence-Working memory is a form of short-term memory centered on what you are currently thinking about, its important because it involves not only being able to store information for a brief period of time but also the ability to mentally manipulate that information, therefore training a person on a specific working memory task would improve performance on that specific task. Training also increased unrelated cognitive skills, including the ability to reason and solve new problems totally independent of previously acquired knowledge, in essence a person may be able to engage the abstraction of thoughts and ideas as readily as applying knowledge-based reasoning.
Implicit Theories of Intelligence-Use the Incremental Theory of Intelligence mindset which proposes that intelligence and ability are malleable traits which can be improved upon through effort and hard work. There is a perceived possibility of mastery even when initial ability to perform a task is low. This possibility of mastery contributes in part to intrinsic motivation of individuals to perform a task, since there is perceived potential for success in the task. Problems can be corrected through effort, leading incrementalistic individuals to continually seek any situation that will intellectually better themselves. Individuals with an incremental mindset will take feedback and channel that into determination to try new strategies for solving a given problem and are more effective at self-regulated learning, ultimately leading them to be more productive at developing plans for learning. Incremental individuals generally have positive and stable self-esteem. Task involvement goals involve individuals aiming to improve their own abilities. Individuals who believe they have the ability to grow and add to their knowledge gladly accept challenges that can aid in growth towards mastery. Individuals who believe their abilities are fixed will also accept and persist through challenges as long as they feel they will succeed and their abilities will not be questioned. Incrementalistic individuals tend to have stronger negotiating skills, believing that with effort a better deal can be reached. This finding may have implications for more favorable working conditions for those with incrementalistic beliefs.
Understanding Everyday Risks (Risk Preferences)—A general factor of individual risk preference, which remains stable over time. Importantly, that factor cannot be assessed by conventional behavioral tests, which often yield contradictory results. What is the nature of the risk preference driving risk-related decisions? Does people's willingness to take risk depend on the context or is it largely consistent across situations? According to findings from the large-scale Basel-Berlin Risk Study, both are correct. Findings indicate that risk-taking propensity has a psychometric structure similar to that of psychological personality characteristics. Like the general factor of intelligence, there is also a general factor of risk preference. But our finding of a general factor of risk preference—based on self-reports and frequency measures of actual risky activities—suggests that risk preference is a personality characteristic in its own right. This insight will make it possible to examine the biological underpinnings of risk preference in future studies Specifically:
   They collected self-reports of risk-taking propensity in hypothetical scenarios.
   Ran experimental behavioral tests involving financial incentives.
   Asked participants about their actual risky activities in everyday life.
Satisficing vs Optimal Decision Making-Satisficing is a decision-making strategy or cognitive heuristic that entails searching through the available alternatives until an acceptability threshold is met. Optimal Decision Making is concerned with finding the best solution available and is more resource intensive. When making decisions using satisficing, the first decision that achieves the desired outcome may be picked despite the potential drawbacks. When trying to make an optimal decision, the decision-making process would be continued in order to mitigate the drawbacks. Lack of information decreases optimization.

### EXAMPLES

The system and computer-implemented method for creating digital pathways between financial service providers and consumers disclosed herein is further illustrated by the following example, which is provided for the purposes of demonstration rather than limitation.

The purpose of the inventive system and method is:
Provide Credit Union Finance/Loan LENDERS a real source for legitimate client lead.
Provide USERS seeking auto loans a source for legitimate loan contact with reputable lenders in their area.
Provide lending education to consumers visiting the site by offering resources, links and materials from trustworthy financial entities

Users coming to this website are looking lenders in their area who can help them get an auto loan without stress or hassle. The goal of the inventive system and method is to give users peace of mind when shopping for auto loans, putting them in control by allowing them to choose the lender(s) they wish to hear from.

The frontend website will consist of two sections: Users and Partners. The first section is the USER section. This part of the website will be the “brochure” of the company. It will include the “Who We Are”, “Financial Education”, “Frequently Asked Questions”, consumer financial information and helpful links, and other content that will help those seeking auto loans learn more. Throughout the website, the user will also see re and carefully vetted advertising chosen and placed on the site to enhance their experience and not overwhelm or frustrate.

The inventive system and method site will allow users to quickly and simply get the information they are looking for. The homepage will have a user-friendly navigation, and a modern look/feel. Final design, look, and feel will be created when the project begins.

The website will be mobile responsive, allowing users to view and navigate the site on any device, using any size screen. The mobile version of the website will be user-friendly. The frontend USER section will consist of a User Form, allowing the user to enter specific information/answers to questions asked. The form will be concise and easy to use. It will encourage users to continue by reminding them that their information will not be shared, and that the lenders shown in their results want to help them have a good auto purchase experience.

Users will fill out a short form to determine their auto loan needs and see which lenders in the system match those needs; then they will have the ability to choose if they want to select the lenders they'd like to have contact them, or if they would like the system to choose for them.

The first screen of the User form will simply ask for the User's Zip Code and vehicle loan type (new or refinance). After the user confirms their agreement to the system's Privacy Policy, they will click to move to the next screen. This simple first step will engage users quickly and easily.

While the example is directed to target auto loan customers, the system could be built to include options for additional financial services such as Mortgage, Insurance, Personal Loans, Student Loans, etc. This would require further detail to determine the questions needed in the User Form process.

The second screen of the User Form will request basic information (amount requested (if known/or pre-approval “up to”), name, email, phone) along with any necessary questions from the lenders. Each lender has different qualifications they may need for loan application, so each will be consulted as they sign up to ensure the user form addresses any required questions. For example, we will need fields for Qualifications, Locations, etc. This will allow any Credit Unions only allowing certain professions or areas to weed out unqualified candidates. Any “additional” question dropdowns will be managed by Super Admins in the Settings tab of the backend (more to follow below). Additional questions could be “Length of Loan Desired”, “Down Payment Amount”.

After the first screen (FIG. 1), the user will see a “preview” of the number of lenders in their area. This teaser will explain that filling out additional information will allow the site to return even more targeted results and lender information. If the user would like to see lender information, they must submit this information to the inventive system and method system. This ensures that the inventive system and method obtains the user's information for marketing purposes, and the user is not able to retrieve the Credit Union member list without fully using the system.

The system should be built in a way that Credit Union information is safeguarded as much as possible while making the gathering of information easy for users.

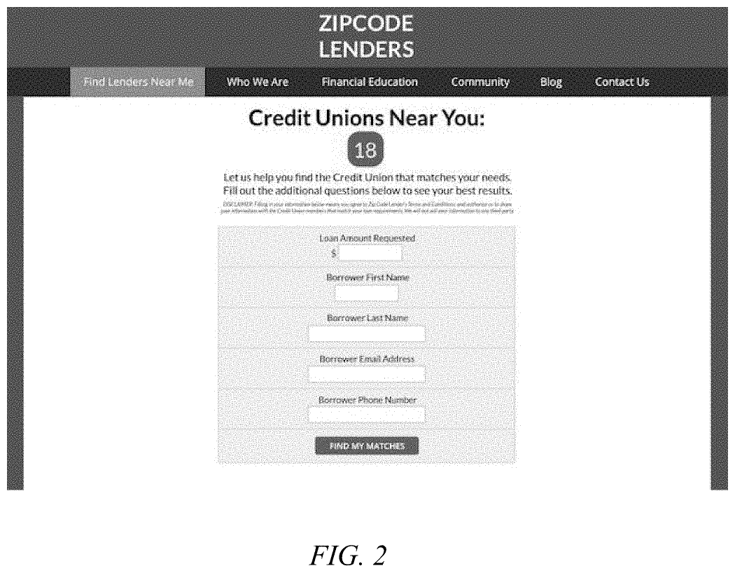

The second screen (FIG. 2) may have additional questions added, such as estimated down payment amount, Last Four of SSN, employment, etc. to filter results. These questions will be added based on the needs of member credit unions and will be determined during the full project build.

The system may do a ‘soft pull’ credit check on each user to check pre-qualification for Credit Unions. No real authorization is needed, but system would let user know and give them the ability to ‘opt-in’ by going to the second form step. Last four of SSN may be required. This will be determined during design and buildout with more information from the lending institutions.

This screen will also have paid lender advertising on it. These ads will be filtered based on the Zip Code entered on Screen One and will not be clickable. They will be visual ads for impression only. See Ad Manager information below for more detail.

After the second screen, the user will see listing of the lenders who match their criteria.

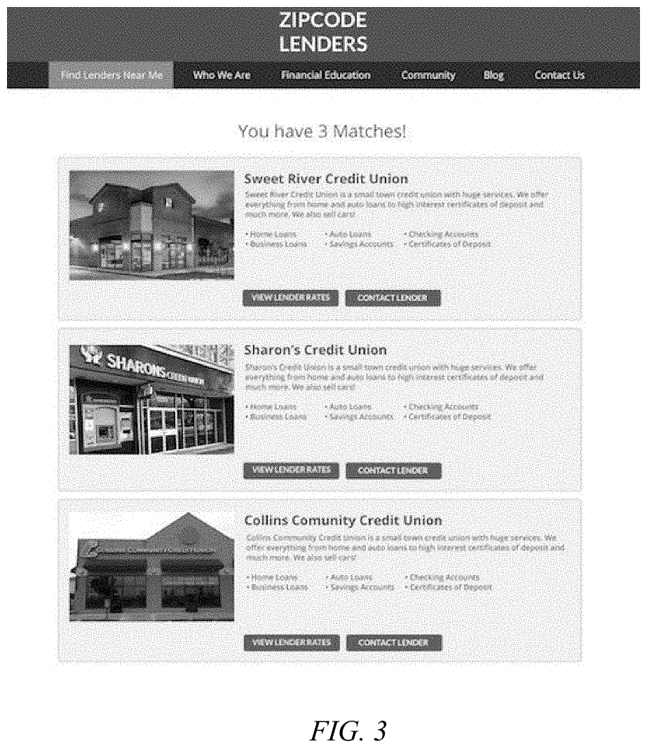

The third screen (FIG. 3) will show the user their lender results in a clean and concise manner, but without address or contact information. The user will be shown a snapshot of the Credit Union's services offered, then have the option to view more detail or select the lender. If the lender is selected, both the User and the Lender will be notified via email with the appropriate contact information so follow-up can be made. Results will be shown randomly unless a lender(s) has paid for premium listing. Premium Listing will be an add-on feature for lenders that will ensure they show at the top of search results.

This screen will also have paid lender advertising on it. These ads will be filtered based on the Zip Code entered on Screen One and question responses given in Screen Two. If lenders meet Zip Code and response criteria and have an ad running, they will show randomly on this page.

The results page will allow the user to see the LENDERS matching their search criteria. The available LENDER list will be based on the user's location (Zip Code) and responses to additional questions. All matching lenders will receive the user's information.

Each lender result box will show a simplified view of information. The top of the page should have a disclaimer letting the user know the results shown are from partner organizations working directly with the inventive system and method to encourage use of the system.

The user might see the Credit Union logo, city/state, and any basic information they have given (such as hours, online banking, mobile app available, etc.). They will have some quick action buttons to view the Lender Rates if available and to Contact the Lender directly through the system.

This final Lender Results page will also have a confirmation message and the ability for the user to print their lender results list for future reference.

Credit Union Lenders will join the inventive system and method as members. They will join by clicking a link on the homepage and creating an account. This can either be done by the LENDER directly, or with the assistance of the inventive system and method Admin.

In order to begin setting up their account, they will be entered:
Credit Union Name
Credit Union Contact Email
Credit Union Contact Phone
Accept Terms/Privacy Policy, etc

Each of these fields will populate any corresponding fields in the following signup screens.

When the Partner Signup button is clicked at the bottom, the lender will begin setting up their account and selecting their lead preferences.

Basic agency information will be entered on this page:
Credit Union Name (pulled from previous login screen)
Email Address (pulled from previous login screen)
Lender Contact Name (pulled from previous login screen)
Phone Number
License Number (or some other certification number to validate their FDIC???)
Street Address 1
Street Address 2
City
State (dropdown list)
Zip
Number of branches
Description
Photo Upload field (to allow lender to upload a photo of their Log

Additional information such as rates and services offered can be added after signup. This shortens the signup process. Lenders will pay a fee to the inventive system and method for signup, for monthly service, and for each lead they receive. When a lender/Credit Union signs up with the inventive system and method system, they will select their monthly automated payment package or select to pay annually at a discounted rate. Their package will allow them access to the system and determine the number of referrals they may receive per month.

Each lender will sign up for the system on an automated monthly recurring payment. Each month, the system will automatically pull the appropriate amount from the lenders account. To end the monthly recurring charge, the lender must call the inventive system and method to cancel with at least a 30-day notice. We also suggest that annual pay lenders be made aware that refunds are not allowed. After the initial contact information is entered, the lender will choose a level of payment for membership with the inventive system and method.

The final section in the Lender signup process is the payment. Here the lender will enter credit card information, authorize recurring credit card billing, enter billing address, and select if they wish to pay monthly or annually.

Now that the lender has joined the inventive system and method, it's time to get some leads. As users come to the website and begin to search for auto lenders, lender members of the system will begin to see activity on their Dashboard. The Dashboard will show a snapshot of lead activity and account information in a quick view, easy-to-read format.

The sections of the Dashboard are (from top to bottom/left to right):
Account Status: Account status is either:
   On—lender is actively receiving leads
   Off—lender is not receiving leads and account is on hold
Member Level: Quick view badge showing the membership level (gold, platinum, diamond, etc.
Leads: This section allows the lender to view, sort, filter, and track all the leads received from the inventive system and method.
   Lender can filter by lead type
   Lender can search by any field or date
   Each lead will show date of lead receipt, Name of lead, phone number, email address, and Zip Code, along link to view additional details.
   Lender can click the name of each lead to view additional details and information on the user and their request.

Each lead received by a Lender will be shown in their Dashboard. When the lead Name is clicked, the Lead Details screen will appear, giving the Lender full details of the lead. The lead details section will contain contact information, responses to the user form, information on the loan desired, and a Notes section where the Lender

The printable Lead Sheet will give the Lender a one-page (8.5″×11″, US standard Letter sized) printout for each lead. The page will contain all information and detail found on the Lead Details page in a clean and professional format.

On the Account tab, the lender can manage personal and Credit Union contact information. This tab is very simple with the following fields:
Top Left Column—Profile Information (lender)
   First Name
   Last Name
   Title
   Street Address 1
   Street Address 2
   City
   State
   Zip
   Phone
   Fax
   Email Address
   License
Top Right Column—Credit Union Information
   Credit Union Name
   Branch Location
   Status (On/Off)
   Membership Level
   Salesperson (The inventive system and method employee pulled from dropdown of Admins list)
Bottom of the Page—Logo Upload and Description Fields

The inventive system and method system will allow each lender to manually add and update their lending rates within the system to give users a quick look view of loan rates without the need to go to another website. As rates change, the lender will need to come back and update their rates in the system to avoid confusion. This is entirely optional. If no rates are entered, there will be no “View Rates” button on the Lender Results page.

Each Lender will have the ability to list their services for potential customers to see on the Lender Results pages. The Service Listing section will be a simple checkbox area, managed in the CMS Settings by Zip Code Lender Admin Users, allowing the Lender to check the services they offer. If a desired service is not listed, the Lender can request that a Zip Code Lender Admin User add it for them. This will be a simple and efficient process.

The billing tab (no comp) is where the lender will manage payment information and view payment history, invoicing, and transaction information. This section will consist of the following areas:
Card on file: The lender will be able to review, edit, and replace the credit card on file for his recurring payment.
Statements: The lender will be able to click to choose from a dropdown the statement they wish to review, then download the PDF version of the statement, or open it in a browser.
Transactions: This grid will show the history of the lender's monetary transactions with the inventive system and method.
Date of Transaction (FULL YYYY/MM/DD)
Name (DESCRIPTION OF CHARGE)
Monthly Account Renewal
Featured Ad
Account Manager Monthly Fee
Initial Deposit
Amount of transaction (IN USD $##.##)
Billing information: Lender can manage, update, edit billing information quickly and easily.

After signup, a Lender can choose some optional value-added features to enhance the inventive system and method experience. The Add-Ons screen allows them to do this. Add-Ons will be finalized during buildout, but could be Premium Listing or Ad Placements, as described below.

If a Lender wishes to have priority coverage on the User Results screen, they can purchase the Premium Listing Add-On. This Add-On will ensure that when each user form is filled out, the results shown are randomized only AFTER the premium lenders are shown. The lender must match the user's search criteria to show on the results page. If the lender matches and has purchased the Premium Listing Add-On, they will show at the top of the results list. If multiple lenders match and have purchased the Premium Listing Add-On, the premium lenders will show randomly, then non-premium lenders will show randomly.

We may opt to offer multiple tiers of Premium Listings, whereby a lender can choose to be a gold, diamond, or platinum Premium Listing. If so, the algorithm will be updated to reflect the need to show higher tier lenders first. For example: Lender A is a Gold Premium, Lender B is a Diamond Premium and Lender C is a non-Premium lender; all three match User Z's criteria; Lender B would show first, followed by Lender A, then Lender C.

If Lender A is a Gold Premium, Lender B is a Gold Premium and Lender C is a non-Premium lender; all three match User Z's criteria; Lenders A and B would be randomized at the top of the list, then Lender C.

A Lender can purchase a Featured Advertisement to provide a showcase for the lender. Pricing for the Ad will be directly derived from the settings tab. The inventive system and method staff edit pricing in the Ad Settings section, as explained in further detail below.

The Featured Ads can be shown in multiple places on the website. Ads can rotate randomly each time a user visits the site. Lenders will have the opportunity to purchase featured ad space on the Inventive system and method using the Featured Ads tab on the Lender Portal pages. When logged in to the Lender Account Dashboard, the Featured Ads tab will be visible to all lenders. Upon clicking the tab, Lenders will see the Featured Ads screen with the following fields:
Lender Name—prefilled from Lender Account information
Credit Union Name—prefilled from Lender Account information
Phone Number—prefilled from Lender Account information
City—prefilled from Lender Account information
State—prefilled from Lender Account information
Select Ad Location on Website:
   Show Ad on web site Homepage
   Show Ad on interior page (any)
   Show Ad on Lender Results page of User Form
Ad Text: (length will be based on the size of the ad, which will be based on the location selected above)
   What would you like your Ad to say?—Lender will enter their requested ad copy for the featured ad. The maximum character count is 255 (show character countdown).
   Would you like to add a photo? (Option to use current photo or upload a new one—photo will be sized automatically to fit the ad sizing requirements)
Ad Length
   72 Hours
   One Week
   One Month
   Ad Cost—predetermined cost shown in this field is based on location of ad placement on web site (table in Settings tab to be editable by the inventive system and method Admin.

Example: if Joe Lender wishes to run an ad, he would select the Featured Ads tab, verify his information and update any necessary, select the Ad location (for instance, Any Interior Website Page), and the Ad Length (say One Week). They system would calculate his Ad cost based on the Ad Settings Table in the CMS.

The Featured Ads will be shown in multiple places on the website. Ads will rotate randomly each time a user visits the site.

Homepage ad placement: The full Featured Ad will be shown on the homepage at the bottom of the page. This will not be clickable to avoid users going off-site before using the system.

Lender Results List: The full Featured Lender Ad will be shown on the results page of the User Form.

Interior Website Page ad placement: The full Featured Add will be shown on any interior page of the website (either on the left/right margin or the bottom, depending on design). This will not be clickable to avoid users going off-site before using the system.

Creating the structure of the Inventive system and method and Lender Lead generation system will be a complex task. The backend will be built on's Content Management System (CMS). This will give the inventive system and method staff and website administrators the ability to update the website content quickly and easily.

A Multi-Tab structure will make navigating the various sections of the backend user-friendly and convenient. The backend will consist of the following tabs:
Web Content—contains the web site content
Admins—contains the website administrator information, including admin groups; this includes only the inventive system and method staff and Account Managers
Users—the section containing the database of website users who fill out the ‘Find a Lender’ form
Lenders—the section containing the database of Lenders who sign up to get leads from the web site
Credit Unions—management of Credit Union Selection (important if allowing lenders from multiple branches of the same CU to join the system)
Ad Manager—the tool that allows lenders to pay for ad space on the website
Reports—the section allowing admins to create and run reports on any stored information in the databases (if you see the word Queries in any of the comps, please replace with Reports)
Settings—the section allowing admin users with permission to edit certain dropdown fields
Emails—the automated email administration system allowing admin to create and edit emails

The standard CMS Web Content tab will allow admin to log in with username and password access and edit website content, update photos, manage website pages, and maintain the look of the Inventive system and method. Each page on the site will have a separate section on which you will use the familiar WYSIWYG or “what you see is what you get” module to easily make these edits.

The second tab in the backend system is the Admins tab. This section will contain the list of administrators and staff of the inventive system and method's website and Lender portal system. Each administrator will have username and password access to the backend system. Access levels will be based on the Group they are in.

The system gives Admin users full access to all webpages and/or all tabs within the backend of the CMS. The Admin user can also create and edit user Groups. Each Group can be assigned to specific pages of the website. Each group can also be assigned to specific tabs. For example, a Group called Account Managers may be created, and this group would be given access to the Lenders tab and Reports tab, only to allow them to administer the Lenders who join the inventive system and method. This allows for targeted and secure user-level controls over your website content. Administrators will only see and have access to the areas of the website they have permission to edit.

As users visit the website and fill out the User Form, their information is collected and stored in the Users section of the database in the CMS.

When an admin clicks the Users tab, they will see the main Users screen, which consists of a listing of all Users. The Admin can search the listings and sort the listings by clicking up/down arrows per column. Clicking the edit icon will open a popup window with the user's full form information details.

As Credit Union Lenders join the inventive system and method by filling out the Lender Setup form, their information is collected and stored in the Lenders section of the database in the CMS. This will be a simple ‘member’ database allowing the inventive system and method admin to view and edit Lender information, tracking details and manage communications with Lenders.

When an admin clicks the Lenders tab, they will see the main Lenders screen, which consists of a listing of all Lenders. The Admin can search the listing. Four filter options are available:
Credit Union Name
Member Level ($)
Account Status

The fields shown for each Lender listing are as follows:
ID
First Name
Last Name
Credit Union
Member Level ($)
Leads
Lender Since
Status

Clicking the edit icon will allow the Admin to view all details and information on the lender and lender account. There is also a button to “Add New Lender” that will allow an Admin to manually add a new Lender to the database.

Each Lender account will contain important basic contact information, along with notes, rankings, and payment information. On the Add/Edit Lender screen, the Admin can view/edit/review all of this information quickly and easily.

When the edit icon next to a Lender's name is clicked on the Lenders tab, the Add/Edit Lender screen will pop up, showing the full information for the Lender including the following:
Name
Phone Number
Address fields
Time Zone (dropdown list)
Account Manager (dropdown from list)
Lender Code
Credit Union Name
Member Level ($)

This screen will also have additional buttons for other lender information screens including:
Payment Options—During the setup process, each Lender will input payment options for recurring payment. Those payment options will be visible on this tab.

A cancel and save/close button will allow the Admin to save changes or to cancel without saving changes to the Lender's information.

When NOTES is clicked on the Add/Edit Lender screen, the Notes modal will pop up, allowing the Account Manager to view all notes on the Lender's account. Notes will allow the Lender to comment to Account Managers quickly and easily. Modal will have the following fields:
Lead Name: The name of the lead/user the lender is filing a note about.
Note Date: Date the note was entered into the system.
Note Type: Dropdown based on field in Settings of CMS. Note Types will be determined by the inventive system and method staff.
Reason: Dropdown based on field in Settings of CMS. Reasons will be determined by the inventive system and method staff.
Note: The text comment field—limit of 250 characters.
Context: (eyeball icon is clickable) Account Manager will click this icon to view the entire details of the note, in case line item view was too long for column width.
Action:
   Text Bubble: if the note is a general comment, a text bubble will appear allowing the Account Manager to click and return a comment.
   If note is a request for credit, icons will be green or red “thumbs up” and “thumbs down” to allow Account Manager to approve or deny request.
      When either thumb icon is clicked, a “Response to Lender” box will appear allowing the Account Manager to leave an explanation of approval or denial.

On an Agency Tab in the CMS, create an Agency Manager system. This is where a drag/drop functionality will exist for the above page to allow an Admin to add Agencies with Logo image and put them in whatever order they like by dragging and dropping them accordingly. Also will have Admin in the Settings tab of CMS to allow the inventive system and method to “prioritize” results by Credit Union if desired.

Admin will enter information above for each Agency in the settings area of the CMS. Agencies can be drag/drop in the order needed. Agencies will be shown in result based on their location in the list.
Credit Union Name
Credit Union Logo Upload
Membership Requirements
State Located (can be multiple states)

The Ad Manager will allow Lenders to purchase a Featured Advertisement to provide the lender a showcase to users visiting the Inventive system and method. See above for Featured Ad scope. Advertisements will be shown in the same style as Lender Results page, on the homepage, interior pages, and on Agency Selection page. Advertisements will be shown randomly on the homepage, agency selection page, and lender results page.

The Reports tab of the CMS will allow the inventive system and method Admins to create and run reports to gather important and valuable information from your system. The Reports system will be divided into three areas to allow for targeted reporting.

The Settings tab of the CMS will allow Admin users the ability to update and edit certain dropdown menu items on the User Form and Lender Sign Up Form frontend pages. This easy-to-use system makes it possible to handle quick updates of information without the need to contact your programmers. Not all dropdown menu items will be available on the settings tab, as there are some that may cause instability if edited improperly. However, your team will give you a quick, safe access point to update all of the menu item settings possible, giving you even more freedom and flexibility, and most importantly, control over your website.

Each dropdown menu item will be contained in a toggle field. When clicked, the current field data will expand, allowing the Admin to select and edit, even add new items to the list.

The final tab in your CMS is the Emails tab. This area allows you to manage some of the automated emails for the inventive system and method users, Lenders, and staff in one location.

The top section will have pre-created automated emails that will be sent when a form is submitted or an Lender joins The inventive system and method will work with the inventive system and method to create these dynamic, text-based emails prior to launching the site.
Staff Emails (Email Me when):
   A new email will be sent to the inventive system and method staff when a Lender joins the inventive system and method system.
   A new email will be sent to the inventive system and method staff when a Lender messages a comment.
Lender Emails:
   A new email will be sent to the Lender when joining the inventive system and method.
   A new email will be sent to the Lender when they receive a new lead.
   A new email will be sent to the Lender to notify them that their monthly recurring charge is about to be pulled from their account.
Web User Emails:
   A new email will be sent to the Web User when they submit a Lender Info request form will setup a maximum of ten (10) pre-created automated emails for the inventive system and method during Phase I.

The bottom section will allow the inventive system and method staff to manually set up their own automated reminder emails. These emails can be used to contact users six months after their form was submitted, contact Lenders one month after they sign up to remind them of the availability of Featured Ad space, etc. The below project estimate is based on the current understanding of the scope and functionality of the project outlined in the above document and design comps as a custom website front-end website design with responsive mobile scaling to fit Smartphones and Tablets of all shapes and sizes, as well as a front-end signup system, and a back-end Content Management System with the specified nine tabs. The price includes an open, flexible, easy to use content management system on the back end, along with database creation, and training.

As used herein, the term “computer” may refer, but is not limited to a laptop or desktop computer, or a mobile device, such as a desktop, laptop, tablet, cellular phone, smart phone, personal media user (e.g., iPod), wearable computer, implantable computer, or the like. Such computing devices may operate using one or more operating systems, including, but not limited to, Windows, MacOS, Linux, UNIX, iOS, Android, Chrome OS, Windows Mobile, Windows CE, Windows Phone OS, Blackberry OS, and the like.

As used herein, the term “mobile device” may refer, but is not limited to any computer, as defined herein, that is not fixed in one location. Examples of mobile devices include smart phones, personal media users, portable digital assistants, tablet computers, wearable computers, implanted computers, and laptop computers.

The system and process described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The systems and/or processes described herein, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as .NET and C++, a lightweight data-interchange programming language such as JavaScript Object Notation (JSON) data-interchange format over HTTP POST request/response, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each process described above, and combinations thereof may be embodied in computer executable code that, when executing on one or more computing devices, performs the steps thereof. In another aspect, the processes may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

It is to be understood that were the specification or claims refer to relative terms, such as “front,” “rear,” “lower,” “upper,” “horizontal,” “vertical,” “above,” “below,” “up,” “down,” “top,” “bottom,” “left,” and “right” as well as derivatives thereof (e.g., “horizontally,” “downwardly,” “upwardly” etc.), such reference is used for the sake of clarity and not as terms of limitation, and should be construed to refer to the orientation as then described or as shown in the drawings under discussion. These relative terms are for convenience of description and do not require that the apparatus be constructed or the process to be operated in a particular orientation.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Processes of the instant disclosure may be implemented by performing or completing manually, automatically, or a combination thereof, selected steps or tasks.

The term “process” may refer to manners, means, techniques and procedures for accomplishing a given task including, but not limited to, those manners, means, techniques and procedures either known to, or readily developed from known manners, means, techniques and procedures by practitioners of the art to which the invention belongs.

For purposes of the instant disclosure, the term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)—(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a process comprising two or more defined steps, the defined steps can be carried out in any order or simultaneously (except where context excludes that possibility), and the process can also include one or more other steps which are carried out before any of the defined steps, between two of the defined steps, or after all of the defined steps (except where context excludes that possibility).

Still further, additional aspects of the instant invention may be found in one or more appendices attached hereto and/or filed herewith, the disclosures of which are incorporated herein by reference as if fully set out at this point.

Thus, the present invention is well adapted to carry out the objects and attain the ends and advantages mentioned above as well as those inherent therein. While the inventive concept has been described and illustrated herein by reference to certain illustrative embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A computer-based information system for creating digital pathways between financial service providers and consumers as disclosed herein.

2. A computer-implemented method for creating digital pathways between financial service providers and consumers as disclosed herein.
